(19) United States
(12) Patent Application Publication
(10) Pub. No.: US 2024/0327150 A1
(43) Pub. Date: Oct. 3, 2024

(54) IMAGE FORMING APPARATUS

(71) Applicant: FUJIFILM Business Innovation Corp., Tokyo (JP)

(72) Inventor: Yoshinori KOIKE, Kanagawa (JP)

(73) Assignee: FUJIFILM Business Innovation Corp., Tokyo (JP)

(21) Appl. No.: 18/354,656

(22) Filed: Jul. 19, 2023

(30) Foreign Application Priority Data
Mar. 28, 2023 (JP) 2023-051925

(51) Int. Cl. B65H 5/00

(52) U.S. Cl. CPC B65H 5/006; B65H 2301/31; B65H 2402/442; B65H 2404/71; B65H 2553/80; B65H 2801/06

(57) ABSTRACT

An image forming apparatus includes an apparatus body that has an image forming portion which forms an image on a recording medium, a transport unit that includes a middle transport member which transports the recording medium between an upper end and a lower end of a transport path extending in a height direction of the apparatus body and that transports the recording medium to the image forming portion along the transport path, and a feeding unit that includes a stacking unit which has a stacking surface on which recording media are stacked and a restricting unit which protrudes from the stacking unit and which restricts positions of the recording media stacked on the stacking unit, that is adjacent to the transport path in a width direction of the apparatus body, and that is switched between a stored state where the stacking unit is stored inside the apparatus body such that the stacking surface is along the transport path and an exposed state where the stacking unit is exposed to an outside of the apparatus body such that the recording media are capable of being stacked on the stacking surface, in which the middle transport member of the transport unit is disposed at a position that is shifted upward in the height direction and that overlaps in the width direction with respect to the restricting unit in the feeding unit in the stored state.

### CROSS-REFERENCE TO RELATED APPLICATIONS

This application is based on and claims priority under 35 USC 119 from Japanese Patent Application No. 2023-051925 filed Mar. 28, 2023.

### BACKGROUND

### (i) Technical Field

The present invention relates to an image forming apparatus.

### (ii) Related Art

JP2014-144851A discloses a feeding device including a placement tray where recording paper is placed, a restricting member that restricts the position of the recording paper placed on the placement tray and that has a guide unit higher than the thickness of a recording paper bundle that can be placed on the placement tray, and a link mechanism that supports the placement tray to be movable between a stored position and a feeding position. In a case where the placement tray is moved from the feeding position to the stored position by the link mechanism in the feeding device, the guide unit of the restricting member is stored in a storing unit.

### SUMMARY

There is an image forming apparatus including a feeding unit that is adjacent to a transport path, in which a recording medium is transported along a height direction of an apparatus body, in a width direction of the apparatus body and that is switched between a stored state where a stacking unit is stored inside the apparatus body such that a stacking surface on which recording media are stacked is along the transport path and an exposed state where the stacking unit is exposed to the outside of the apparatus body such that the recording media can be stacked.

In such an image forming apparatus, in a case where the feeding unit is in the stored state, for example, it is preferable that a transport member that transports the recording media and a restricting unit that restricts the positions of the recording media stacked on the stacking unit, which are in the transport path adjacent to the feeding unit, are disposed so as not to interfere with each other. However, in a case where the transport member and the restricting unit are disposed at positions shifted from each other in the width direction of the apparatus body such that the transport member and the restricting unit do not interfere with each other, an increase in the size of the apparatus in the width direction is likely to be achieved.

Aspects of non-limiting embodiments of the present disclosure relate to an image forming apparatus that makes the size of the apparatus small compared to a case where the transport member that transports the recording media is disposed at a position shifted with respect to the restricting unit in the width direction.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present invention, there is provided an image forming apparatus including an apparatus body that has an image forming portion which forms an image on a recording medium, a transport unit that includes a middle transport member which transports the recording medium between an upper end and a lower end of a transport path extending in a height direction of the apparatus body and that transports the recording medium to the image forming portion along the transport path, and a feeding unit that includes a stacking unit which has a stacking surface on which recording media are stacked and a restricting unit which protrudes from the stacking unit and which restricts positions of the recording media stacked on the stacking unit, that is adjacent to the transport path in a width direction of the apparatus body, and that is switched between a stored state where the stacking unit is stored inside the apparatus body such that the stacking surface is along the transport path and an exposed state where the stacking unit is exposed to an outside of the apparatus body such that the recording media are capable of being stacked on the stacking surface, in which the middle transport member of the transport unit is disposed at a position that is shifted upward in the height direction and that overlaps in the width direction with respect to the restricting unit in the feeding unit in the stored state.

### BRIEF DESCRIPTION OF THE DRAWINGS

Exemplary embodiment(s) of the present invention will be described in detail based on the following figures, wherein:

FIG. 1 is an overall view of an image forming apparatus to which the present exemplary embodiment is applied;

FIG. 2 is an enlarged view of the surroundings of a fourth transport path of the image forming apparatus shown in FIG. 1;

FIG. 3 is a perspective view showing a configuration of a second paper supply unit of the present exemplary embodiment;

FIG. 4 is a view showing a relationship between a feeding unit and the fourth transport path; and

FIG. 5 is a view for describing a change in relative positions of a first guide member and a second guide member with respect to an opening and closing cover.

### DETAILED DESCRIPTION

Hereinafter, an exemplary embodiment of the present invention will be described in detail with reference to the accompanying drawings.

### Image Forming Apparatus 1

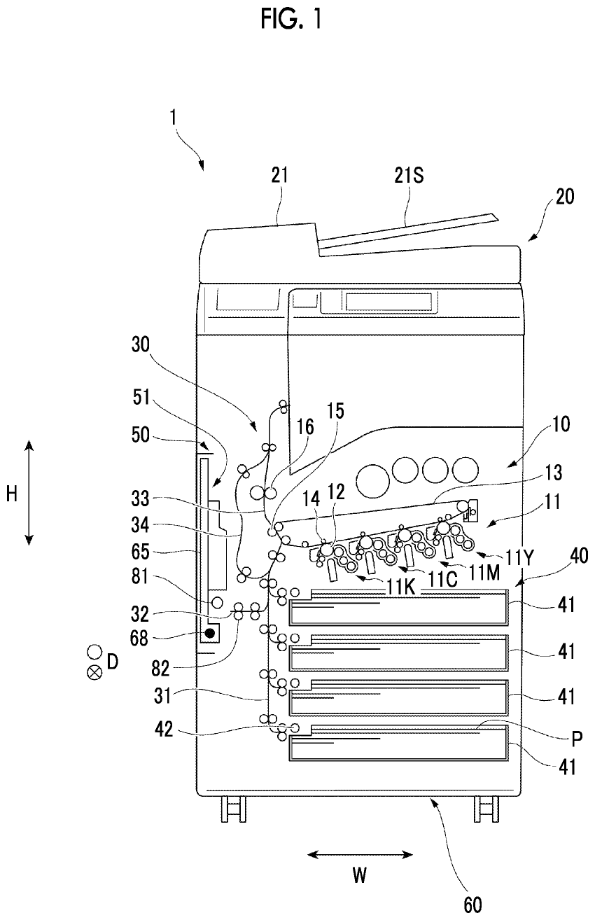

FIG. 1 is an overall view of an image forming apparatus 1 to which the present exemplary embodiment is applied.

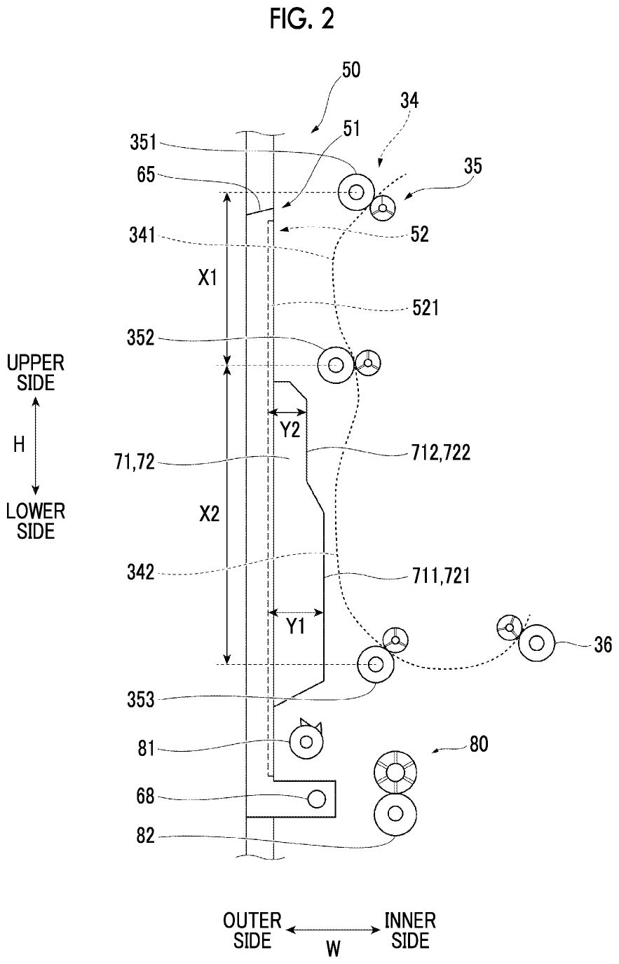

The image forming apparatus 1 includes an image forming portion 10 that performs image forming corresponding to image data of each color, an image reading device 20 that reads an image, a paper transport unit 30 that transports paper P which is a recording medium, and a first paper supply unit 40 that supplies the paper P to the image forming portion 10. In addition, the image forming apparatus 1 includes a second paper supply unit 50 that is an example of a feeding unit which supplies the paper P to the image forming portion 10. Further, the image forming apparatus 1 includes a housing 60 that accommodates the image forming portion 10, the paper transport unit 30, and the first paper supply unit 40. Although details will be described later, the housing 60 is provided with an opening and closing cover 65 that is provided to be openable and closable and that switches a paper stacking unit 52 (see FIG. 2) of the second paper supply unit 50 between a stored state and an exposed state.

In the description of the present exemplary embodiment, a direction in which a front side and a back side of the page are linked to each other in the image forming apparatus 1 shown in FIG. 1 will be defined as a depth direction D of the image forming apparatus 1. In addition, in the image forming apparatus 1 shown in FIG. 1, a right-left direction of the page will be defined as a width direction W of the image forming apparatus 1, and an up-down direction of the page will be defined as a height direction H of the image forming apparatus 1.

The image forming portion 10 includes four image forming units 11 (11Y, 11M, 11C, 11K) disposed in parallel at regular intervals. Each of the image forming units 11Y, 11M, 11C, and 11K includes a photosensitive drum 12 that forms an electrostatic latent image and that holds a toner image and forms the toner image through an electrophotographic method. The image forming units 11Y, 11M, 11C, and 11K respectively form yellow (Y), magenta (M), cyan (C), and black (K) toner images.

In addition, the image forming portion 10 includes an intermediate transfer belt 13 to which a toner image of each color formed on the photosensitive drum 12 of each image forming unit 11 is transferred. In addition, the image forming portion 10 includes a primary transfer roll 14 that sequentially transfers (primarily transfers) a toner image of each color formed by each image forming unit 11 to the intermediate transfer belt 13. Further, the image forming portion 10 includes a secondary transfer unit 15 that collectively transfers (secondarily transfers) a toner image of each color formed by being superimposed onto the intermediate transfer belt 13 to the paper P and a fixing unit 16 that fixes the secondarily transferred toner image of each color to the paper P.

The image reading device 20 reads an image formed on a document and transmits the read data to a control unit (not shown) of the image forming portion 10 or other devices (not shown) provided outside the image forming apparatus 1. In addition, the image reading device 20 includes a paper sending device 21 that transports the paper P stacked on a stacking unit 21S one by one in turn toward a reading sensor provided at the image reading device 20 in order to read an image on the paper P.

The paper transport unit 30 includes a first transport path 31 in which the paper P supplied from the first paper supply unit 40 is transported toward the secondary transfer unit 15, a second transport path 32 in which the paper P supplied from the second paper supply unit 50 is transported toward the secondary transfer unit 15, and a third transport path 33 in which the paper P is transported from the secondary transfer unit 15 to the fixing unit 16 and is discharged to the outside of the image forming apparatus 1. Further, the paper transport unit 30 has a fourth transport path 34 that branches from the third transport path 33 and in which the paper P, of which front and back sides are reversed by passing through the fixing unit 16, is again transported to the secondary transfer unit 15.

The first transport path 31, the second transport path 32, the third transport path 33, and the fourth transport path 34 of the paper transport unit 30 are provided with a plurality of transport rolls that transport the paper P.

The first paper supply unit 40 includes a plurality of paper accommodating units 41. In addition, each paper accommodating unit 41 is provided with a sending roll 42 that sends out the accommodated paper P. The first paper supply unit 40 sends out the paper P from each paper accommodating unit 41 with the sending roll 42 and supplies the paper P to the paper transport unit 30.

### Fourth Transport Path 34

Next, the fourth transport path 34 in the paper transport unit 30 will be described. FIG. 2 is an enlarged view of the surroundings of the fourth transport path 34 of the image forming apparatus 1 shown in FIG. 1.

As shown in FIG. 2, the fourth transport path 34 extends along an up-down direction H of the image forming apparatus 1. In addition, the paper P of which front and back sides are reversed by passing through the fixing unit 16 (see FIG. 1) is transported in the fourth transport path 34 from an upper side toward a lower side of the image forming apparatus 1 along the up-down direction H.

As shown in FIG. 2, the paper transport unit 30 includes a plurality of transport rolls 35 that transport the paper P along the fourth transport path 34. Specifically, the paper transport unit 30 includes an upper transport roll 351 that is provided on the upper side in the up-down direction H in the fourth transport path 34, a lower transport roll 353 that is provided on the lower side in the up-down direction H in the fourth transport path 34, and a middle transport roll 352 that is provided between the upper transport roll 351 and the lower transport roll 353. Each transport roll 35 is configured by a pair of roll members that face each other with the fourth transport path 34 sandwiched therebetween and that are rotatable about a rotation shaft.

Further, the paper transport unit 30 includes a delivery roll 36 that delivers the paper P transported along the fourth transport path 34 by the plurality of transport rolls 35 toward the image forming portion 10.

Hereinafter, in the fourth transport path 34, a section from the upper transport roll 351 to the middle transport roll 352 will be written as an upper transport path 341, and a section from the middle transport roll 352 to the lower transport roll 353 will be written as a lower transport path 342 in some cases.

The fourth transport path 34 of the present exemplary embodiment has a curved shape such that each of the upper transport path 341 and the lower transport path 342 inflates to an outer side (the left in FIG. 2) of the image forming apparatus 1 in the width direction W. In addition, the upper transport path 341 between the upper transport roll 351 and the middle transport roll 352 inflates to the outer side of a portion where the paper P is transported by the upper transport roll 351 and a portion where the paper P is transported by the middle transport roll 352 in the width direction W. Similarly, the lower transport path 342 between the middle transport roll 352 and the lower transport roll 353 inflates to the outer side of the portion where the paper P is transported by the middle transport roll 352 and a portion where the paper P is transported by the lower transport roll 353 in the width direction W.

In addition, the fourth transport path 34 of the present exemplary embodiment has a curved shape such that the portion where the paper P is transported by the middle transport roll 352, which is a boundary between the upper transport path 341 and the lower transport path 342, inflates to an inner side (the right in FIG. 2) in the width direction W.

In the present exemplary embodiment, as the lower transport path 342 has a shape curved to the outer side in the width direction W, for example, in a case where the paper P is paper having high stiffness such as cardboard, resistance when the paper P has approached the lower transport roll 353 can be reduced.

As shown in FIG. 2, a distance X1 between the upper transport roll 351 and the middle transport roll 352 along the up-down direction H is shorter than a smallest length of each of sheets of paper P, which can be transported in the fourth transport path 34 in the image forming apparatus 1, along a paper transport direction (hereinafter, written as a minimum paper length of the image forming apparatus 1). Accordingly, as the paper P is simultaneously transported by the upper transport roll 351 and the middle transport roll 352 in the upper transport path 341, a transport failure of the paper P is unlikely to occur.

Similarly, a distance X2 between the middle transport roll 352 and the lower transport roll 353 along the up-down direction H is shorter than the minimum paper length of the image forming apparatus 1. Accordingly, as the paper P is simultaneously transported by the middle transport roll 352 and the lower transport roll 353 in the lower transport path 342, a transport failure of the paper P is unlikely to occur.

Herein, in the fourth transport path 34 of the present exemplary embodiment, the distance X2 between the middle transport roll 352 and the lower transport roll 353 is longer than the distance X1 between the upper transport roll 351 and the middle transport roll 352 (X2>X1). The distance X1 between the upper transport roll 351 and the middle transport roll 352 is a length along the height direction H between roll members positioned on the outer side in the width direction W among the roll members configuring the upper transport roll 351 and the middle transport roll 352. Similarly, the distance X2 between the middle transport roll 352 and the lower transport roll 353 is a length along the height direction H between roll members positioned on the outer side in the width direction W among the roll members configuring the middle transport roll 352 and the lower transport roll 353.

As the distance X2 between the middle transport roll 352 and the lower transport roll 353 is longer than the distance X1 between the upper transport roll 351 and the middle transport roll 352 in the fourth transport path 34, the lower transport path 342 is longer than the upper transport path 341. Accordingly, it is possible to make the curvature radius of the lower transport path 342 curved to inflate to the outer side in the width direction W even larger, and the transport resistance of the paper P that is transported in the lower transport path 342 can be further reduced.

A relationship between each transport roll 35 (in particular, the middle transport roll 352) in the fourth transport path 34 and the second paper supply unit 50 will be described in detail later.

### Second Paper Supply Unit 50

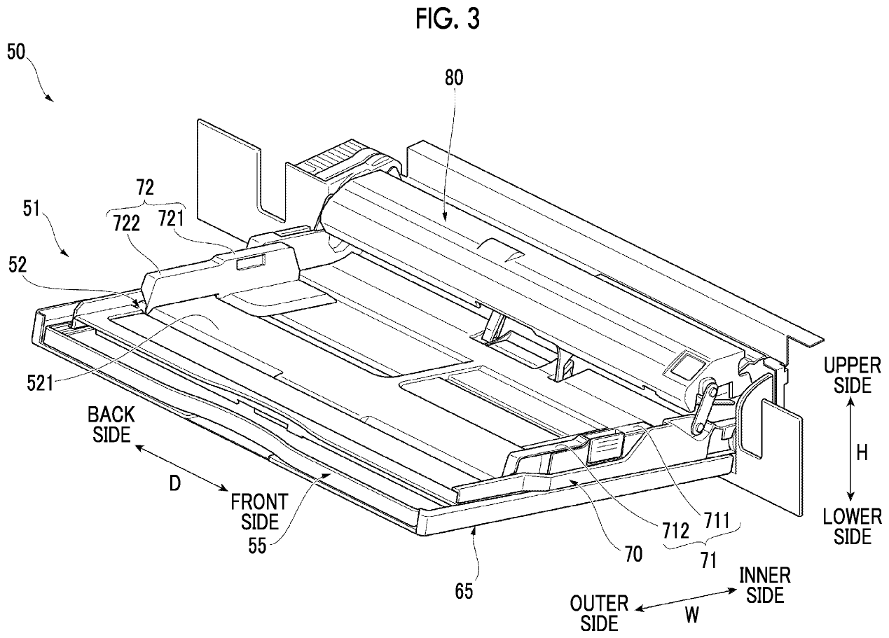

FIG. 3 is a perspective view showing a configuration of the second paper supply unit 50 of the present exemplary embodiment.

As shown in FIG. 3, the second paper supply unit 50 has a feeding unit 51 that is an example of the feeding unit on which the paper P supplied toward the image forming portion 10 is stacked and a paper transport unit 80 that transports the paper P stacked on the feeding unit 51 toward the image forming portion 10.

The second paper supply unit 50 is a so-called manual feed tray. In addition, in a case where image forming is performed on the paper P having a size selected by a user, the second paper supply unit 50 sets the paper P having the selected size in order to supply the paper P to the image forming portion 10. The second paper supply unit 50 of the present exemplary embodiment can supply atypical paper, for example, from relatively small paper such as a postcard to, for example, A3-sized paper at maximum toward the image forming portion 10.

In response to an opening and closing operation of the opening and closing cover 65 that is openable and closable with respect to the housing 60 (see FIG. 1), the feeding unit 51 of the second paper supply unit 50 is switched between an exposed state where the feeding unit 51 is exposed to the outside of the image forming apparatus 1 such that the paper P can be stacked on the paper stacking unit 52 to be described later and a stored state where the feeding unit 51 is stored in a storing unit 61 formed in the housing 60. In addition, the opening and closing cover 65 is provided to be rotatable about a hinge 68 that is an example of a rotation shaft attached to the housing 60, opens and closes by rotating about the hinge 68, and switches the feeding unit 51 between the exposed state and the stored state.

FIG. 3 shows the second paper supply unit 50 in which the feeding unit 51 is in the exposed state.

The feeding unit 51 includes the paper stacking unit 52 that is an example of a stacking unit on which the paper P is stacked, an expansion unit 55 that expands a place where the paper P is stacked in addition to the paper stacking unit 52, and a paper guide unit 70 that guides the paper P toward the paper transport unit 80.

The paper stacking unit 52 has a paper stacking surface 521 that is an example of a stacking surface which extends along the width direction W and the depth direction D and which faces the upper side in the height direction H in a case where the feeding unit 51 is in an exposed state. In addition, the paper stacking unit 52 is a place where a bundle of a plurality of sheets of paper P (hereinafter, written as a paper bundle) transported by the paper transport unit 80 are stacked on the paper stacking surface 521. In the paper stacking unit 52 of the present exemplary embodiment, the transport direction in which the paper P is transported is the width direction W of the image forming apparatus 1.

Although details will be described later, as shown in FIG. 2, in a case where the feeding unit 51 is in a stored state, the paper stacking surface 521 of the paper stacking unit 52 extends along the height direction H and the depth direction D and faces the inner side in the width direction W. In addition, in a case where the feeding unit 51 is in the stored state, the paper stacking surface 521 of the paper stacking unit 52 is along the fourth transport path 34 extending in the height direction H.

In a case where the feeding unit 51 is in an exposed state, the expansion unit 55 is disposed below the paper stacking unit 52 in the height direction H. In addition, in a state of being pulled out with respect to the paper stacking unit 52, the expansion unit 55 expands a surface for stacking the paper P in addition to the paper stacking surface 521. In the example, the expansion unit 55 is pulled out to the outer side in the width direction W with respect to the paper stacking unit 52. In a state of being pulled out, the expansion unit 55 enables placing, for example, A3-sized paper at maximum together with the paper stacking unit 52. On the other hand, in a case where the user does not use the expansion unit 55, the expansion unit 55 is stored below the paper stacking unit 52.

The paper guide unit 70 includes a first guide member 71 that is provided on the front side in the depth direction D of the image forming apparatus 1 and that guides paper stacked on the paper stacking unit 52 and a second guide member 72 that is provided on the back side in the depth direction D and that guides the paper stacked on the paper stacking unit 52 by being paired with the first guide member 71. The first guide member 71 and the second guide member 72 are examples of a restricting unit. In the present exemplary embodiment, the first guide member 71 and the second guide member 72 have shapes symmetrical with respect to a plane perpendicular to the depth direction D. In addition, in a case of being viewed along the depth direction D, the first guide member 71 and the second guide member 72 have the same outer shape.

In a case where the feeding unit 51 is in an exposed state, the first guide member 71 and the second guide member 72 are provided to protrude upward in the height direction H from the paper stacking surface 521 of the paper stacking unit 52.

Although details will be described later, as shown in FIG. 2, in a case where the feeding unit 51 is in a stored state, the first guide member 71 and the second guide member 72 protrude to the inner side in the width direction W from the paper stacking surface 521 of the paper stacking unit 52.

Hereinafter, a height at which the first guide member 71 or the second guide member 72 protrudes from the paper stacking surface 521 will be written as a protruding height of the first guide member 71 or the second guide member 72 in some cases.

To describe specifically, in a case where the feeding unit 51 is in an exposed state, the first guide member 71 includes a downstream guide unit 711 that is positioned on the inner side in the width direction W and that has a first protruding height Y1 and an upstream guide unit 712 that is adjacent to the downstream guide unit 711 on the outer side in the width direction W and that has a second protruding height Y2 smaller than the first protruding height Y1. In the first guide member 71, the downstream guide unit 711 is positioned on a downstream side in the transport direction of the paper P stacked on the paper stacking surface 521, and the upstream guide unit 712 is on an upstream side in the transport direction of the paper P to be adjacent to the downstream guide unit 711. In addition, in a case where the feeding unit 51 is in a stored state, the downstream guide unit 711 is positioned on a lower side in the up-down direction H, and the upstream guide unit 712 is positioned on an upper side in the up-down direction H with respect to the downstream guide unit 711.

In addition, in a case where the feeding unit 51 is in the stored state, in the first guide member 71, the upstream guide unit 712 is recessed to the outer side in the width direction W with respect to the downstream guide unit 711. The upstream guide unit 712 is an example of a recessed portion in the first guide member 71.

Similarly, in a case where the feeding unit 51 is in an exposed state, the second guide member 72 includes a downstream guide unit 721 that is positioned on the inner side in the width direction W and that has the first protruding height Y1 and an upstream guide unit 722 that is adjacent to the downstream guide unit 711 on the outer side in the width direction W and that has the second protruding height Y2. In the second guide member 72, the downstream guide unit 721 is positioned on the downstream side in the transport direction of the paper P stacked on the paper stacking surface 521, and the upstream guide unit 722 is on the upstream side in the transport direction of the paper P to be adjacent to the downstream guide unit 721. In addition, in a case where the feeding unit 51 is in a stored state, the downstream guide unit 721 is positioned on the lower side in the up-down direction H, and the upstream guide unit 722 is positioned on the upper side in the up-down direction H with respect to the downstream guide unit 721.

In addition, in a case where the feeding unit 51 is in the stored state, in the second guide member 72, the upstream guide unit 722 is recessed to the outer side in the width direction W with respect to the downstream guide unit 721. The upstream guide unit 722 is an example of a recessed portion in the second guide member 72.

In addition, the first guide member 71 and the second guide member 72 restrict the position of the paper P on the paper stacking surface 521 by coming into contact with end surfaces of the paper P (or, a paper bundle), which is stacked on the paper stacking surface 521, on the front side and the back side in the depth direction D.

In addition, the first guide member 71 and the second guide member 72 are movable on the paper stacking unit 52 in the depth direction D. In the present exemplary embodiment, the first guide member 71 and the second guide member 72 move such that a movement amount while one moves and a movement amount while the other moves are the same. Accordingly, the paper guide unit 70 restricts the position of the paper P on the paper stacking surface 521 in the depth direction D such that a central portion of the paper P in the depth direction D matches a position on the paper stacking unit 52 determined in advance. Then, as the paper guide unit 70 restricts the position of the paper P on the paper stacking surface 521 in the depth direction D, meandering of the paper P transported from the paper stacking unit 52 to the second transport path 32 is suppressed.

With reference to FIG. 1 as well, the paper transport unit 80 includes a pickup roll 81 that picks up the uppermost paper P stacked on the paper stacking unit 52 and a feed roll 82 that sends the paper P picked up by the pickup roll 81 to the downstream side in the transport direction. The feed roll 82 sends the paper P picked up by the pickup roll 81 to the second transport path 32.

### Relationship Between Feeding Unit 51 and Fourth Transport Path 34

Next, a relationship between the feeding unit 51 in a stored state and the fourth transport path 34 will be described in more detail.

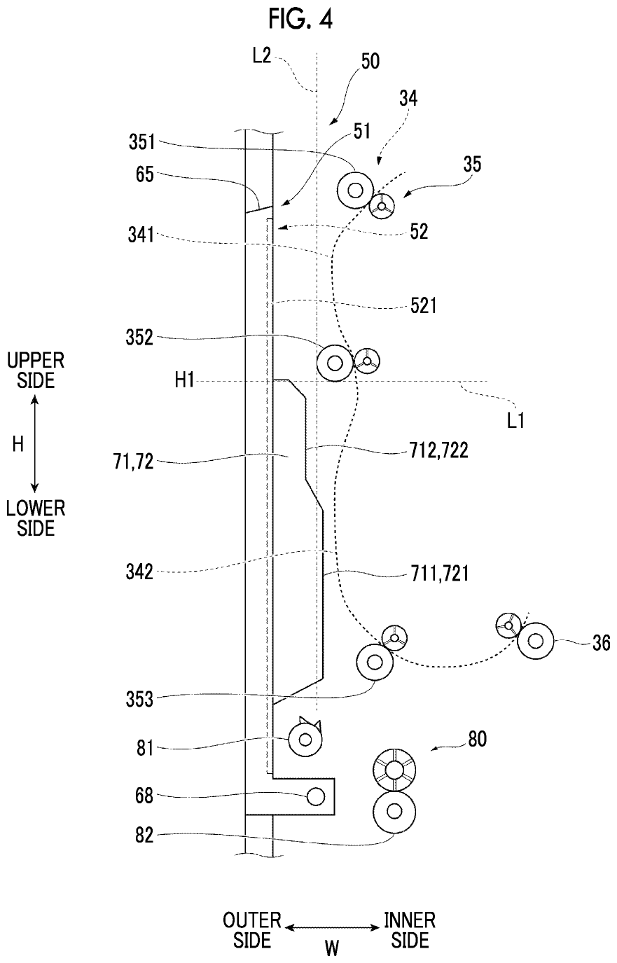

FIG. 4 is a view showing the relationship between the feeding unit 51 and the fourth transport path 34. As in FIG. 2, FIG. 4 corresponds to an enlarged view of the surroundings of the fourth transport path 34 of the image forming apparatus 1 shown in FIG. 1. In addition, FIG. 4 corresponds to a view in which the feeding unit 51 and the fourth transport path 34 are viewed along a rotation shaft direction of the roll member configuring each transport roll 35. Herein, the opening and closing cover 65 is closed with respect to the housing 60, and the feeding unit 51 is in a stored state.

As shown in FIG. 4, the middle transport roll 352 in the fourth transport path 34 is disposed at a position that is shifted upward in the height direction H and that overlaps in the width direction W with respect to the first guide member 71 and the second guide member 72 in the feeding unit 51 in a stored state. Hereinafter, a relationship between the middle transport roll 352 and the first guide member 71 will be generally described, but the same also applies to a relationship between the middle transport roll 352 and the second guide member 72.

In the image forming apparatus 1 of the present exemplary embodiment, in a case where the feeding unit 51 is in a stored state, the position of the middle transport roll 352 in the height direction His at a height H1 of an upper end of the first guide member 71 in the height direction H or greater. More specifically, a tangent line L1 that extends in the width direction W from a lower end of an outer circumference of a roll member of the middle transport roll 352, which is positioned on the outer side in the width direction W, in the height direction H is drawn. As shown in FIG. 4, the tangent line L1 overlaps the upper end of the first guide member 71 in the height direction H. Further, the rotation shaft of the roll member of the middle transport roll 352, which is positioned on the outer side in the width direction W, is positioned above the upper end of the first guide member 71 in the height direction H.

As described above, in the image forming apparatus 1 of the present exemplary embodiment, as the middle transport roll 352 is disposed at a position shifted upward in the height direction H with respect to the first guide member 71 and the second guide member 72 in the feeding unit 51 in a stored state, it is suppressed that the first guide member 71 and the second guide member 72 interfere with the middle transport roll 352 in a case where the feeding unit 51 is switched from an exposed state to the stored state.

In addition, as shown in FIG. 2, in the image forming apparatus 1 of the present exemplary embodiment, the distance X2 between the middle transport roll 352 and the lower transport roll 353 is longer than the distance X1 between the upper transport roll 351 and the middle transport roll 352. In other words, in the image forming apparatus 1 of the present exemplary embodiment, the middle transport roll 352 is positioned above the center of the fourth transport path 34 in the height direction H.

Accordingly, compared to a case where the distance X2 between the middle transport roll 352 and the lower transport roll 353 is shorter than the distance X1 between the upper transport roll 351 and the middle transport roll 352, the length of the first guide member 71 in the height direction H in a case where the feeding unit 51 is in a stored state can be made long. Accordingly, compared to a case where the distance X2 between the middle transport roll 352 and the lower transport roll 353 is shorter than the distance X1 between the upper transport roll 351 and the middle transport roll 352, the length of the first guide member 71 in the width direction W in a case where the feeding unit 51 is in an exposed state can be made long.

As a result, in the image forming apparatus 1 of the present exemplary embodiment, the length of the first guide member 71 that comes into contact with an end surface of the paper P, which is stacked on the paper stacking surface 521 and which is transported in the width direction W, can be made long in a case where the feeding unit 51 is in the exposed state. Then, the first guide member 71 makes restricting the position of the paper P on the paper stacking surface 521 in the depth direction D even easier, and thereby meandering of the paper P transported from the paper stacking unit 52 to the second transport path 32 can be further suppressed.

Further, in the image forming apparatus 1 of the present exemplary embodiment, the middle transport roll 352 in the fourth transport path 34 is disposed at a position that overlaps the first guide member 71 in the feeding unit 51 in a stored state in the width direction W. More specifically, a tangent line L2 that extends in the height direction H from the outer side of an outer circumference of the roll member of the middle transport roll 352, which is positioned on the outer side in the width direction W, in the width direction W is drawn. As shown in FIG. 4, the tangent line L2 overlaps the downstream guide unit 711 of the first guide member 71. In the example, the tangent line L2 does not overlap the upstream guide unit 712 of the first guide member 71. In addition, the middle transport roll 352 of the present exemplary embodiment is disposed at a position that overlaps the downstream guide unit 711 of the first guide member 71 in the width direction W and that does not overlap the upstream guide unit 712 in the width direction W.

As described above, in the image forming apparatus 1 of the present exemplary embodiment, as the middle transport roll 352 is disposed at a position that overlaps the first guide member 71 of the feeding unit 51 in a stored state in the width direction W, the size of the image forming apparatus 1 in the width direction W can be made small, for example, compared to a case where the middle transport roll 352 is disposed at a position that does not overlap the first guide member 71 in the width direction W.

Herein, as described above, since the middle transport roll 352 is disposed at a position shifted upward in the height direction H with respect to the first guide member 71 in the feeding unit 51 in the stored state, the middle transport roll 352 and the first guide member 71 do not interfere with each other even in a case where the middle transport roll 352 is disposed at a position that overlaps the first guide member 71 in the width direction W.

In addition, in the image forming apparatus 1 of the present exemplary embodiment, in a case where the feeding unit 51 is in a stored state, the upstream guide unit 712 of the first guide member 71 adjacent to the middle transport roll 352 is recessed to the outer side in the width direction W compared to the downstream guide unit 711. Accordingly, compared to a case where the upstream guide unit 712 is not recessed to the outer side in the width direction W with respect to the downstream guide unit 711, the first guide member 71 and the middle transport roll 352 are more unlikely to interfere with each other in a case where the feeding unit 51 is in the stored state.

In the exemplary embodiment described above, a transport member other than the upper transport roll 351, the middle transport roll 352, and the lower transport roll 353 is not provided as the transport roll 35 of the fourth transport path 34, but the fourth transport path 34 may be provided with other transport members. However, from a viewpoint of suppressing interference between the transport roll 35 of the fourth transport path 34 and the first guide member 71 and the second guide member 72 in the feeding unit 51 in a stored state, for example, it is preferable that the lower transport path 342 curved to inflate toward a feeding unit 51 side is not provided with a transport member other than the middle transport roll 352 and the lower transport roll 353. In this case, compared to a case where the lower transport path 342 is provided with a transport member other than the middle transport roll 352 and the lower transport roll 353, the image forming apparatus 1 can be made smaller in the width direction W.

In the image forming apparatus 1 described above, as the opening and closing cover 65 rotates about the hinge 68, the feeding unit 51 is switched between an exposed state and a stored state. In addition, in a case where the opening and closing cover 65 rotates about the hinge 68, the first guide member 71 and the second guide member 72 of the feeding unit 51 move integrally with the opening and closing cover 65. Accordingly, in the image forming apparatus 1 described above, relative positions of the first guide member 71 and the second guide member 72 with respect to the opening and closing cover 65 are the same between the feeding unit 51 in the exposed state and the feeding unit 51 in the stored state.

However, in the image forming apparatus 1, for example, as the opening and closing cover 65 rotates about the hinge 68 to switch the feeding unit 51 between the exposed state and the stored state, the first guide member 71 and the second guide member 72 are moved with an operation mechanism different from the hinge 68, and thereby relative positions of the first guide member 71 and the second guide member 72 with respect to the opening and closing cover 65 may be changed between the feeding unit 51 in the exposed state and the feeding unit 51 in the stored state.

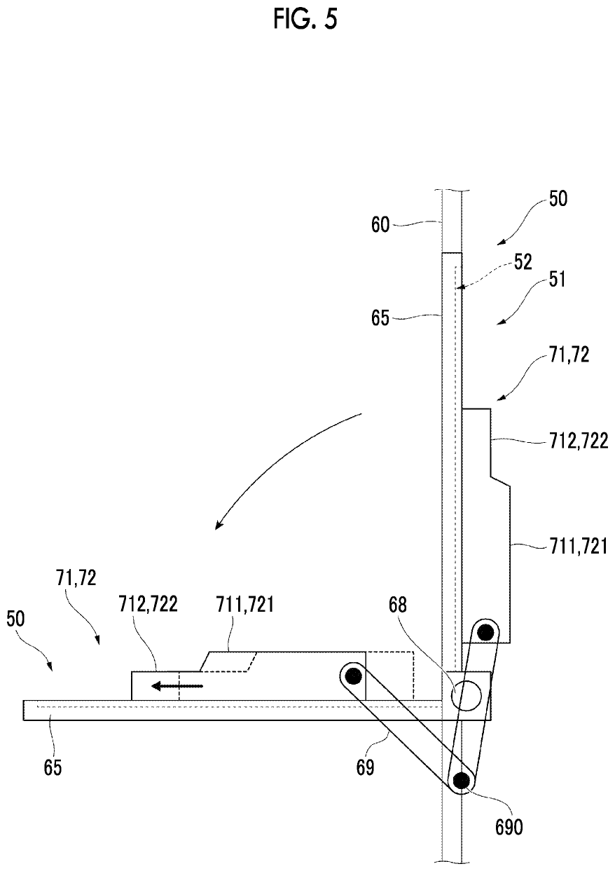

FIG. 5 is a view for describing a change in relative positions of the first guide member 71 and the second guide member 72 with respect to the opening and closing cover 65.

As in the example described above, the opening and closing cover 65 opens and closes by rotating about the hinge 68 attached to the housing 60, and the feeding unit 51 is switched between an exposed state and a stored state.

In addition, in the example shown in FIG. 5, the first guide member 71 and the second guide member 72 are rotated together with the opening and closing cover 65 and are moved relatively with respect to the opening and closing cover 65 by a link mechanism 69 that rotates about a rotation shaft 690 in response to the rotation of the opening and closing cover 65. The rotation shaft 690 of the link mechanism 69 is an example of another rotation shaft, and in the example, the opening and closing cover 65 is disposed at a position shifted downward in the height direction H with respect to the rotating hinge 68.

More specifically, as shown in FIG. 5, in a case where the opening and closing cover 65 rotates about the hinge 68 to switch the feeding unit 51 from a stored state to an exposed state, the first guide member 71 and the second guide member 72 move relatively to the outer side in the width direction W with respect to the opening and closing cover 65 that extends along the width direction W and the depth direction D in the exposed state. In other words, in a case where the opening and closing cover 65 is switched from the stored state to the exposed state, the first guide member 71 and the second guide member 72 move relatively to the upstream side in the transport direction of the paper P on the paper stacking unit 52 with respect to the opening and closing cover 65.

Accordingly, in the feeding unit 51 shown in FIG. 5, it is possible to restrict the position of the paper P stacked on the paper stacking unit 52 in the depth direction D from further upstream side in the transport direction compared to a case where the relative positions of the first guide member 71 and the second guide member 72 with respect to the opening and closing cover 65 do not change in response to the rotation of the opening and closing cover 65. As a result, meandering of the paper P transported from the paper stacking unit 52 to the second transport path 32 can be further suppressed.

A mechanism for moving the first guide member 71 and the second guide member 72 is not limited to the link mechanism shown in FIG. 5 insofar as the relative positions of the first guide member 71 and the second guide member 72 with respect to the opening and closing cover 65 change in response to the opening and closing operation of the opening and closing cover 65.

Although the exemplary embodiment of the present invention has been described hereinbefore, the present invention is not limited to the exemplary embodiment described above. In addition, effects of the exemplary embodiment of the present invention are not limited to the exemplary embodiment described above. Various modifications and alternative configurations are included in the present invention without departing from the technical scope of the present invention.

### Supplementary Note

(((1)))

An image forming apparatus comprising:
an apparatus body that has an image forming portion which forms an image on a recording medium;
a transport unit that includes a middle transport member which transports the recording medium between an upper end and a lower end of a transport path extending in a height direction of the apparatus body and that transports the recording medium to the image forming portion along the transport path; and
a feeding unit that includes a stacking unit which has a stacking surface on which recording media are stacked and a restricting unit which protrudes from the stacking unit and which restricts positions of the recording media stacked on the stacking unit, that is adjacent to the transport path in a width direction of the apparatus body, and that is switched between a stored state where the stacking unit is stored inside the apparatus body such that the stacking surface is along the transport path and an exposed state where the stacking unit is exposed to an outside of the apparatus body such that the recording media are capable of being stacked on the stacking surface,
wherein the middle transport member of the transport unit is disposed at a position that is shifted upward in the height direction and that overlaps in the width direction with respect to the restricting unit in the feeding unit in the stored state.
   (((2)))

The image forming apparatus according to (((1))
wherein the transport unit further includes a lower transport member that is provided below the middle transport member in the transport path and that transports the recording medium transported by the middle transport member toward the image forming portion, and
the transport path between the middle transport member and the lower transport member is curved to protrude toward an outer side of the apparatus body.
   (((3)))

The image forming apparatus according to (((2))),
wherein the transport unit is not provided with another transport member that transports the recording medium in the transport path between the middle transport member and the lower transport member.
   (((4)))

The image forming apparatus according to (((2))) or (((3))),
wherein the transport unit further includes an upper transport member that is provided above the middle transport member in the transport path and that transports the recording medium toward the middle transport member, and
a distance between the middle transport member and the lower transport member is longer than a distance between the upper transport member and the middle transport member.
   ((5)))

The image forming apparatus according to (((4))),
wherein the distance between the middle transport member and the lower transport member is shorter than a length of a minimum recording medium transported in the transport path in a transport direction.
   (((6)))

The image forming apparatus according to any one of (((1))) to (((5))),
wherein the middle transport member of the transport unit transports the recording medium above a center of the transport path in the height direction.
   (((7)))

The image forming apparatus according to any one of (((1))) to (((5))), further comprising:
an opening and closing cover that opens and closes with respect to the apparatus body,
wherein the feeding unit is switched between the stored state and the exposed state in response to an opening and closing operation of the opening and closing cover, and a relative position of the restricting unit with respect to the opening and closing cover differs between the stored state and the exposed state.
   (((8)))

The image forming apparatus according to (((7))),
wherein the opening and closing cover opens and closes with respect to the apparatus body by rotating about a rotation shaft, and
in response to the opening and closing operation of the opening and closing cover, the feeding unit rotates about another rotation shaft shifted from the rotation shaft in the height direction or the width direction and is switched between the stored state and the exposed state.
   (((9)))

The image forming apparatus according to (((1))),
wherein in the feeding unit in the stored state, a lower portion of the restricting unit in the height direction protrudes to an inner side of the apparatus body compared to an upper portion of the restricting unit in the height direction.
   (((10)))

The image forming apparatus according to (((1))),
wherein the restricting unit of the feeding unit in the stored state has a recessed portion that is recessed toward the outside of the apparatus body, and
the transport unit is disposed at a position where the middle transport member is adjacent to the recessed portion in the restricting unit in the width direction and the transport path is curved toward an inner side of the apparatus body.
   (((11)))

The image forming apparatus according to (((1))),
wherein the middle transport member of the transport unit is a roll member that rotates about a rotation shaft, in a case of being viewed in a rotation shaft direction, a tangent line that extends in the width direction from a lower end of an outer circumference of the roll member in the height direction overlaps an upper end of the restricting unit in the stored state in the height direction, and the rotation shaft is positioned above the upper end of the restricting unit in the stored state in the height direction.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an apparatus body that has an image forming portion which forms an image on a recording medium;
a transport unit that includes a middle transport member which transports the recording medium between an upper end and a lower end of a transport path extending in a height direction of the apparatus body and that transports the recording medium to the image forming portion along the transport path; and
a feeding unit that includes a stacking unit which has a stacking surface on which recording media are stacked and a restricting unit which protrudes from the stacking unit and which restricts positions of the recording media stacked on the stacking unit, that is adjacent to the transport path in a width direction of the apparatus body, and that is switched between a stored state where the stacking unit is stored inside the apparatus body such that the stacking surface is along the transport path and an exposed state where the stacking unit is exposed to an outside of the apparatus body such that the recording media are capable of being stacked on the stacking surface,
wherein the middle transport member of the transport unit is disposed at a position that is shifted upward in the height direction and that overlaps in the width direction with respect to the restricting unit in the feeding unit in the stored state.

2. The image forming apparatus according to claim 1,
wherein the transport unit further includes a lower transport member that is provided below the middle transport member in the transport path and that transports the recording medium transported by the middle transport member toward the image forming portion, and
the transport path between the middle transport member and the lower transport member is curved to protrude toward an outer side of the apparatus body.

3. The image forming apparatus according to claim 2,
wherein the transport unit is not provided with another transport member that transports the recording medium in the transport path between the middle transport member and the lower transport member.

4. The image forming apparatus according to claim 3,
wherein the transport unit further includes an upper transport member that is provided above the middle transport member in the transport path and that transports the recording medium toward the middle transport member, and
a distance between the middle transport member and the lower transport member is longer than a distance between the upper transport member and the middle transport member.

5. The image forming apparatus according to claim 4,
wherein the distance between the middle transport member and the lower transport member is shorter than a length of a minimum recording medium transported in the transport path in a transport direction.

6. The image forming apparatus according to claim 1,
wherein the middle transport member of the transport unit transports the recording medium above a center of the transport path in the height direction.

7. The image forming apparatus according to claim 1, further comprising:
an opening and closing cover that opens and closes with respect to the apparatus body,
wherein the feeding unit is switched between the stored state and the exposed state in response to an opening and closing operation of the opening and closing cover, and a relative position of the restricting unit with respect to the opening and closing cover differs between the stored state and the exposed state.

8. The image forming apparatus according to claim 7,
wherein the opening and closing cover opens and closes with respect to the apparatus body by rotating about a rotation shaft, and
in response to the opening and closing operation of the opening and closing cover, the feeding unit rotates about another rotation shaft shifted from the rotation shaft in the height direction or the width direction and is switched between the stored state and the exposed state.

9. The image forming apparatus according to claim 1,
wherein in the feeding unit in the stored state, a lower portion of the restricting unit in the height direction protrudes to an inner side of the apparatus body compared to an upper portion of the restricting unit in the height direction.

10. The image forming apparatus according to claim 1,
wherein the restricting unit of the feeding unit in the stored state has a recessed portion that is recessed toward the outside of the apparatus body, and
the transport unit is disposed at a position where the middle transport member is adjacent to the recessed portion in the restricting unit in the width direction and the transport path is curved toward an inner side of the apparatus body.

11. The image forming apparatus according to claim 1,
wherein the middle transport member of the transport unit is a roll member that rotates about a rotation shaft, in a case of being viewed in a rotation shaft direction, a tangent line that extends in the width direction from a lower end of an outer circumference of the roll member in the height direction overlaps an upper end of the restricting unit in the stored state in the height direction, and the rotation shaft is positioned above the upper end of the restricting unit in the stored state in the height direction.
